(19) United States
(12) Patent Application Publication
(10) Pub. No.: US 2014/0184068 A1
(43) Pub. Date: Jul. 3, 2014

(54) Bi-color Illuminated Emblem

(71) Applicant: Young Chul Kwon, Northridge, CA (US)

(72) Inventor: Young Chul Kwon, Northridge, CA (US)

(21) Appl. No.: 13/728,962

(22) Filed: Dec. 27, 2012

(51) Int. Cl. B60Q 1/00

(52) U.S. Cl. CPC B60Q 1/0088
USPC 315/80

(57) ABSTRACT

A bi-color illuminated decorative device for an automobile includes a metal-look portion having a metal look layer, a substrate layer that supports the metal look layer, and a plurality of illuminating elements; and a controller that is electrically connected to the illuminating elements and that controls the light intensity of the illuminating elements. The illuminating elements are arranged to conform to the shape of the metal-look portion. The metal look layer and the substrate layer pass light from the illuminating elements. The controller controls the light intensity of the illuminating elements depending on ambient light and braking status.

### CROSS REFERENCE TO RELATED APPLICATIONS

This application is a continuation-in-part application based on U.S. patent application Ser. No. 12/059,134, filed by the applicant on Mar. 31, 2008, now abandoned; U.S. patent application Ser. No. 12/263,353, filed by the applicant on Oct. 31, 2008, now pending; U.S. patent application Ser. No. 61/250,786, filed by applicant on Oct. 12, 2009, now expired; and U.S. patent application Ser. No. 12/902,488, filed by applicant on Oct. 12, 2010, now pending, the disclosure of which are incorporated by reference as if fully set forth herein.

### BACKGROUND OF THE INVENTION

This invention is related to an illuminated emblem. More particularly, the invention is related to an illuminated emblem that has a first look as a non-illuminated ordinary emblem in day time, and a second look as an illuminated emblem in night time. The first look and the second look have different colors.

Many emblems for automotive use have hybrid look including colored part and shiny part. In the night time, backlighting effect may be added to the emblem for increased decoration effect and functioning as an indicator may be provided by the backlighting effect.

Emblems by prior art did not provide the combination of integrated and natural look that differs in day and night time, and sufficient brightness of backlighting suitable for automotive use.

### SUMMARY OF THE INVENTION

The present invention contrives to solve the disadvantages of the prior art.

An objective of the invention is to provide a bi-color illuminated emblem that integrates typical day time look of an automotive emblem with back lighted night time look of an automotive part.

Another objective of the invention is to provide a bi-color illuminated emblem that can provide uniform and sufficiently bright illuminated portion.

Still another objective of the invention is to provide a bi-color illuminate emblem that does not accumulate heat and removes heat promptly.

In order to achieve the above objective, the present invention provides a bi-color illuminated decorative device for an automobile, which includes a metal-look portion having a metal look layer, a substrate layer that supports the metal look layer, and a plurality of illuminating elements; and a controller that is electrically connected to the illuminating elements and that controls the light intensity of the illuminating elements.

The illuminating elements are arranged to conform to the shape of the metal-look portion. The metal look layer and the substrate layer pass light from the illuminating elements.

The controller comprises an ambient light sensor that measures the intensity of ambient light, and a brake sensor that is adapted to receive braking signal from the vehicle. The controller controls the light intensity of the light-emitting elements according to the received braking signal. When the ambient light sensor indicates that it is night time and the brake sensor indicates that that the brake is not stepped on, the controller set the light intensity at a first magnitude. When the ambient light sensor indicates that it is night time and the brake sensor indicates that that the brake is stepped on, the controller set the light intensity at a second magnitude, wherein the first magnitude is lower than the second magnitude.

The device further comprises a non-metal look colored portion that is adjacent to the metal-look portion.

The metal-look portion further comprises a light diffusion layer that diffuses light from the illuminating elements. The light diffusion layer comprises a plurality of projections that project from the substrate layer and divert light rays from the illuminating elements.

The metal look layer comprises a metal coating layer. The degree of translucency is controlled with the grains of the metal coating layer.

The metal-coating layer comprises a silver nano painting layer. Preferably, the thickness of the silver nano painting layer is in the range of 3˜5 μm.

The device further comprises a printed circuit board on which the illuminating elements are installed, and the illuminating elements comprise light-emitting diodes.

The illuminating element further comprises a light guiding element that guides the light from the light-emitting diodes within a predetermined angle. Preferably, the predetermined angle is greater than one hundred ten degree.

The printed circuit board comprises a heat conducting plate that is adapted to contact the vehicle, whereby heat generated by the light-emitting diodes is dissipated to the vehicle.

The device further comprises a wire that is adapted to be connected to a wiring harness of the vehicle.

The substrate layer is made of semi-transparent plastic resin.

The metal-look portion further comprises a clear coating on top of the metal look layer for improved weatherability against ultraviolet light.

The illuminated emblem serves purposes of decoration and security warning. The illuminated emblem of the present invention provides the same look and satisfies design requirement of emblem for major automotive companies. That is, the emblem has shiny metal and brilliant color look. The illuminated emblem further provides outstanding decoration effect at dark environment by emitting bright and colored light. The emblem also provides warning effect such as stop signal or turn signal. The emblem provides bright enough directional light required for warning effect in driving situations. The emblem can be provided in many different shape and structure. The outer surface of the emblem may be flat or include convex and concave portions. The emblem provides a uniformly illuminated look while the illuminating elements are discrete due to the scattering effect of the substrate layer and illuminating elements construction.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein;

FIG. 1 is an elevation view showing an emblem having letters and an oval edge strip, and colored part between the letters and the oval edge strip;

FIG. 2 is an elevation view showing an emblem having a polygonal shape and an edge strip that surrounds the polygon;

FIG. 3 is an elevation view showing an emblem including a symbol that has an arbitrary shape and an edge strip that surrounds the symbol, and colored portions inside the symbol and outside the symbol;

FIGS. 4, 5 and 6 are elevation views showing a plurality of illuminating elements that are arranged along the geometrical contour of the illuminated part of the emblems shown in FIGS. 1, 2 and 3;

FIG. 7 is a cross-sectional view taken along line VII-VII on FIG. 5;

FIG. 8 is a plan view of a bi-color illuminated emblem of a second embodiment;

FIG. 9 is a plan view of a base with illuminating elements;

FIG. 10 is a cross-sectional view taken along line X-X in FIG. 8;

FIG. 11 is a plan view of the illuminating element;

FIG. 12 is a cross-sectional view of the illuminating element;

FIG. 13 is an enlarged cross-sectional view of the emblem;

FIG. 14 is a perspective view showing a bi-color license plate according to an embodiment of the invention;

FIG. 15 is a top plan view of a circuit board with a plurality of LEDs of the bi-color license plate of FIG. 14;

FIG. 16 is a block diagram showing a system for bi-color license plate according to another embodiment of the invention;

FIG. 17 is a cross-sectional view along line XVII-XVII of FIG. 14;

FIG. 18 is a cross-sectional view showing low profile LED and tooth-shaped light diffusion layer;

FIG. 19 is a cross-sectional view showing silver nano paint layer;

FIG. 20 is a cross-sectional view showing metal coating layer;

FIG. 21 is an elevation view of a half-cylindrical screw;

FIG. 22 is an elevation view showing a cap having bolt-head shape; and

FIG. 23 is a diagram showing a connection module that connects the illuminated emblem to the wiring harness of a vehicle.

### DETAILED DESCRIPTION OF THE INVENTION

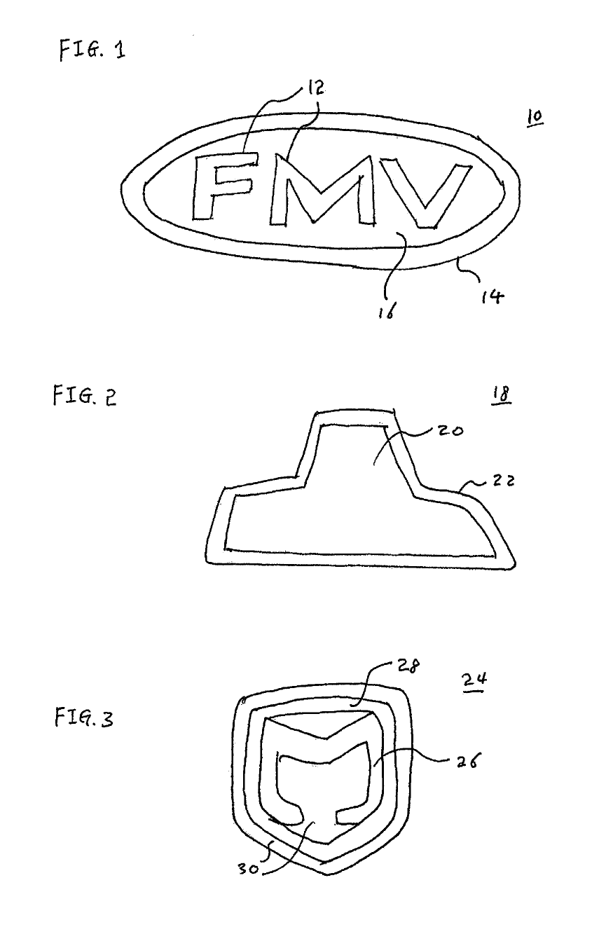

Various decorative attachments are provided on the body of an automobile. The bi-color feature of the present invention is applied to any decorative attachments that are desired to be emphasized. FIGS. 1˜13 show an embodiment for a bi-color emblem and FIGS. 14˜22 show an embodiment for a bi-color license plate.

FIG. 1 shows an emblem 10 that has letters 12 and an oval edge strip 14, and colored part 16 between the letters 12 and the oval edge strip 14. The letters 12 and the oval edge strip 14 have metal look, and the colored part 16 has a color that has a strong contrast with the metal look part, including blue and black. In night time, the letters 12 are illuminated from behind and show red color. The letters 12 are used to represent manufacturer or a model name of a car.

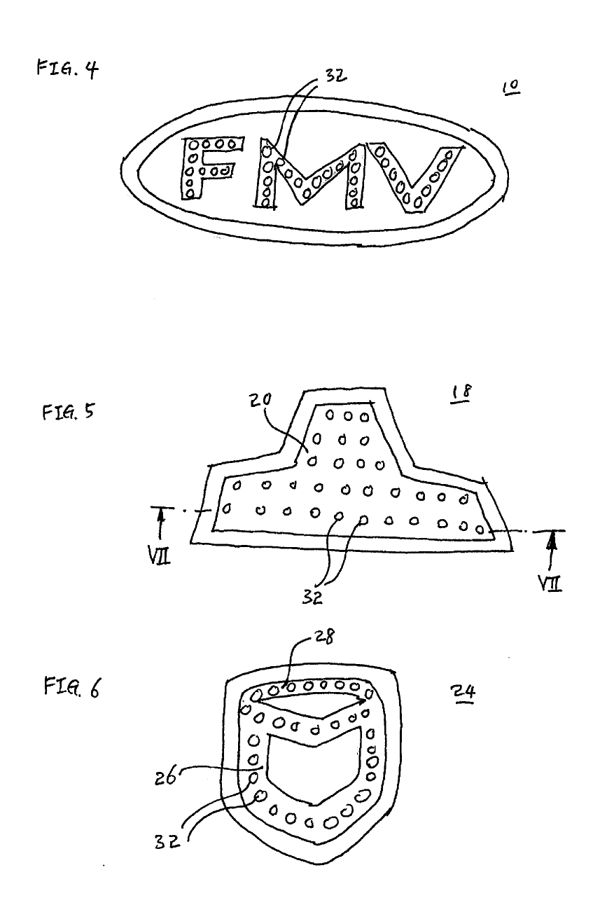

FIG. 2 shows another emblem 18 that has a polygonal center portion 20 and an edge strip 22 that surrounds the polygonal center portion 20. Both of the polygonal center portion 20 and the edge strip 22 have metal look but have different colors. In night time, the polygonal center portion 20 is illuminated from behind and shows a third color, including red. The polygon-shaped emblem 18 is used to represent a logo of an automotive manufacturer.

FIG. 3 shows still another emblem 24 that includes a symbol 26 that may be an arbitrary shape and an edge strip 28 that surrounds the symbol 26, and colored portions 30 inside the symbol 26 and outside the symbol 26. The symbol 26 and the edge strip 28 have metal look, and are illuminated from behind during night time. The symbol 26 is used to represent manufacturer's symbol that has not a regular geometrical shape.

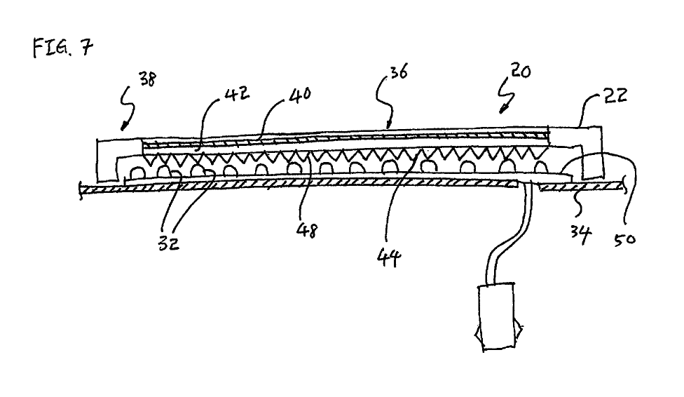

FIG. 4 shows that a plurality of illuminating elements 32 are arranged along contour of the geometrical letters 12.

FIG. 5 shows that a plurality of illuminating elements 32 are arranged along the contour of the geometrical polygonal center portion 20.

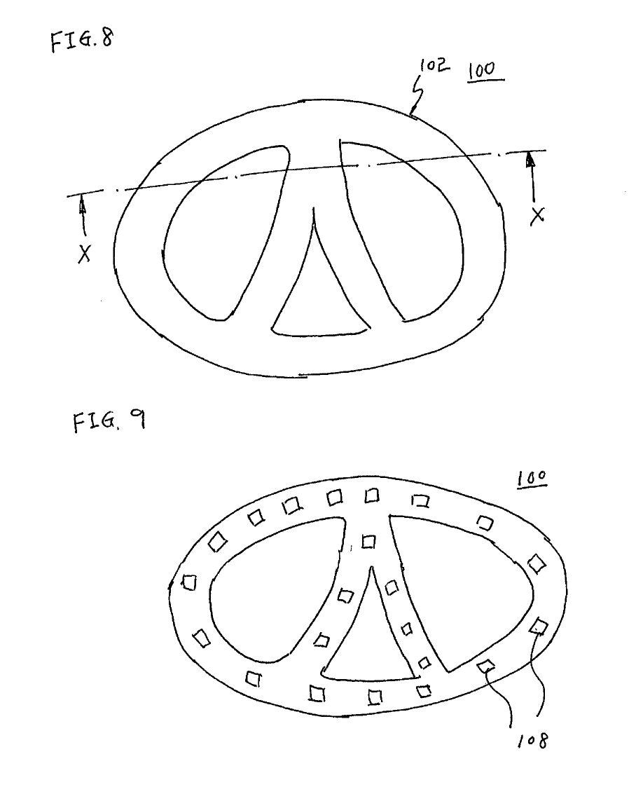

FIG. 6 shows that a plurality of illuminating elements 32 are arranged along the contour of the geometrical symbol 26 and the edge strip 28.

FIG. 7 shows that the bi-color illuminated emblem 18, which is attached on a body panel 14 of an automobile, includes a metal-look portion 36 and a non-metal look colored portion 38 that is adjacent to the metal-look portion 36. The metal-look portion 36 includes a metal look layer 40, a substrate layer 42 that supports the metal look layer 40, a plurality of the illuminating elements 32 and a light diffusion layer 44 that diffuses light from the illuminating elements 32.

The substrate layer 42 provides a medium on which the metal-look layer 40 is firmly attached. Alternatively, the substrate layer 42, itself may be used for bi-color display without the metal look layer 40. A plastic sheet having a commercial name ‘Superglas Dulight’ may be used as the substrate layer 42. The property of Dulight is well explained in Korean Patent No. 10-0596325, the disclosure of which is incorporated by reference. The substrate layer has a property that changes color when it is illuminated. The substrate layer provides bright and directional light when it is illuminated, which is required for warning light for stop or turn signal.

The illuminating elements 32 are arranged to conform to the shape of the metal-look portion 36. The metal look layer 40 and the substrate layer 42 pass light from the illuminating elements 32.

The metal look layer 40 is provided as a metal coated sheet, or is vacuum evaporation coated on the substrate layer 42. The metal coating is made in a density that allows back illuminating. A sheet that is commonly called ‘solar paper’ may be used as the metal look layer 40.

The bi-color illuminated emblem further includes a clear coating 46 on top of the metal look layer 42. The clear coating is provided for protection and for more realistic look. The clear coating renders the multi-layer structure of the emblem like a sold metal emblem. The clear coating is made of epoxy.

The light diffusion layer 44 includes a plurality of tooth elements 48 that are adapted to refract light from the illuminating elements 32 to various directions. The substrate layer 42 and the light diffusion area 44 are integrated and are molded of clear polycarbonate. The bi-color illuminated emblem further includes a base 50 on which the illuminating elements 32 are attached, and the illuminating element comprises an LED. For the illuminating element 32, an LED is used for satisfying durability, brightness, and color requirement of the emblem.

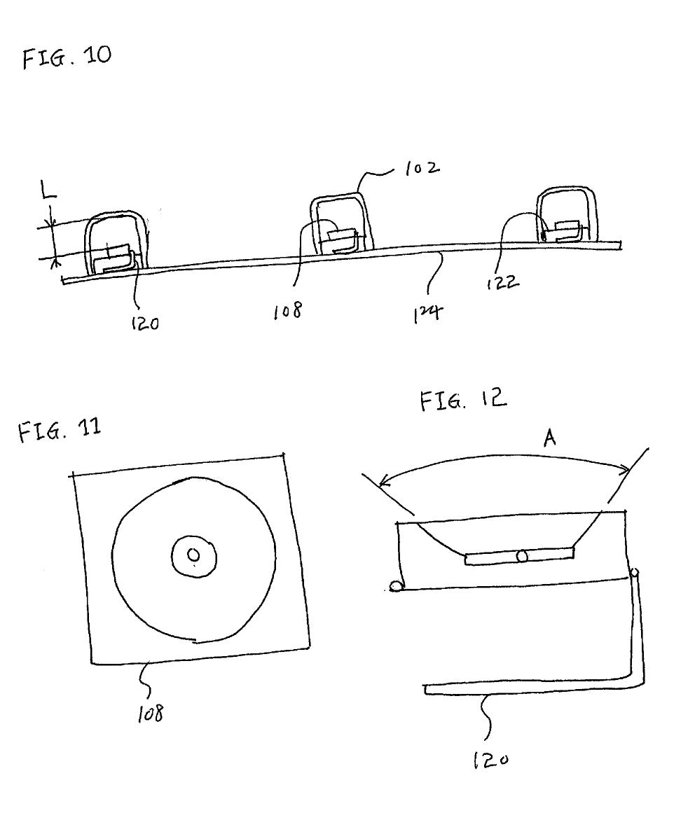

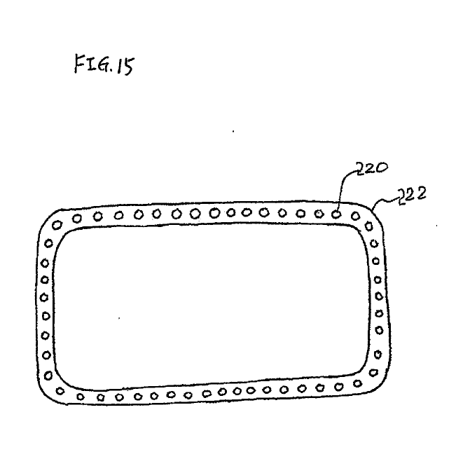

FIGS. 8, 10 and FIG. 13 show a bi-color illuminated emblem 100 that includes a metal-look portion 102 having a metal-look layer 104, a substrate layer 106 that supports the metal-look layer 104, and a plurality of illuminating elements 106.

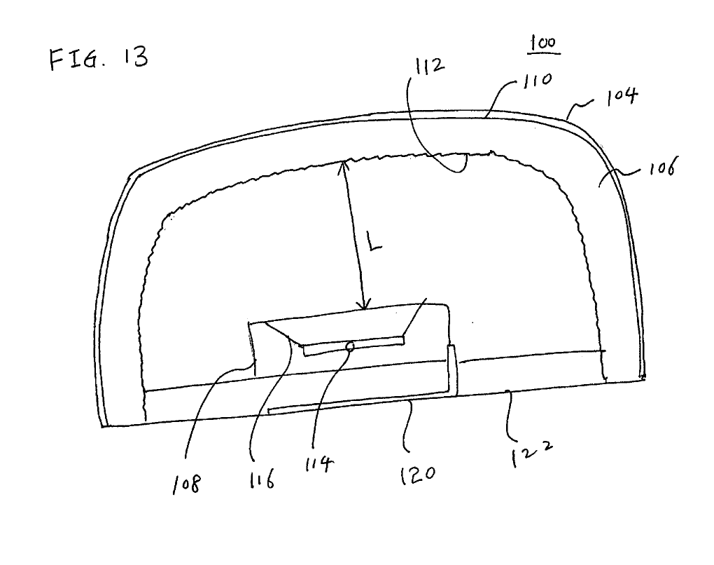

FIG. 9 shows that the illuminating elements 106 are arranged along a curve that conforms to the shape of the metal-look portion 102. The metal look layer 104 and the substrate layer 106 pass light from the illuminating elements 108. The illuminating elements 108 emit light within a predetermined emission angle A (refer to FIG. 12).

Preferably, the predetermined emission angle A is within a range from about 110 degree to about 130 degree. More preferably, the predetermined emission angle is about 120 degree. This wide emission of light helps to provide a more uniform illumination.

The substrate layer 106 is made of semi-transparent PC (polycarbonate), or natural PC. The property of semi-transparency is better than clear PC in making the appearance of the illuminated emblem more uniform. PC is selected for less density change under temperature change thereby eliminating crack of metal-coating layer.

The substrate layer 106 comprises an outer surface 110 which supports the metal look layer 104, and an inner surface 112 that faces the illuminating elements 108 and has coarse texture that causes scattering of light, thus providing more uniform appearance. The coarse texture can be provided by grainy surface of a mold or by scratching the inner surface.

Preferably, the distance L between the inner surface 112 of the substrate layer 106 and the illuminating elements 108 is in a range from 5˜12 mm. More preferably, the distance L is in a range from 7˜10 mm. The distance provides space for scattering and dispersing light from the illuminating element. The illuminating element has a very low profile and that helps to provide more space inside the emblem.

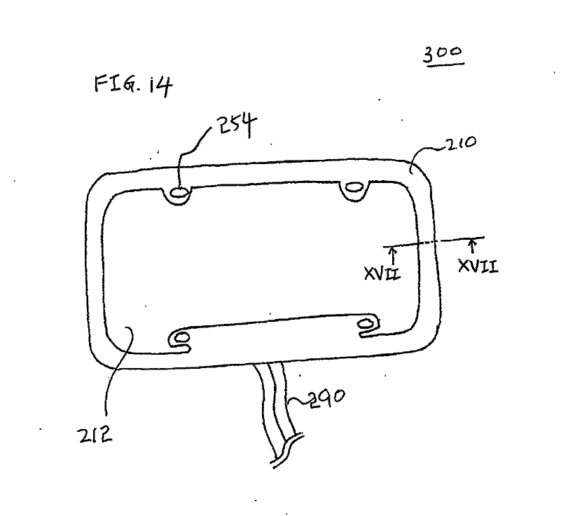

FIGS. 11 and 12 show that the illuminating element 108 comprises an LED 114 and a light guiding element 116 that guides the light from the LED 114 to emit throughout and within the predetermined angle A.

The bi-color illuminated emblem 100 further includes a cooling device 118 for cooling the illuminating elements. The cooling device 118 includes a heat conducting plate 120 that is connected to the illuminating elements 108, and attached to a base 122 that supports the illuminating elements and is attached to a body panel 124 of an automobile. The heat conducting plate 120 removes heat from the LED and transfers the heat to the body panel 124 thereby preventing overheating of the emblem.

Dyes can be added to the plastic resin that makes the decorative attachments to obtain different colors of light diffusion. In one embodiment, the color of the resin component may be reddish. In certain embodiments of the invention, the dyed resin may be coated with metal, which may look metallic in daylight, and translucent to the lights at night. The degree of translucency may be controlled with the grains of metal coating.

A plastic bi-color license plate frame may have metallic chrome coating. Alternatively, the bi-color license plate frame may include other kinds of translucent plastic in addition to natural ABS.

One of the translucent plastic may have a black color under daylight, and translucent enough to pass lights at night.

Still alternatively, the bi-color license plate frame may include a plastic having a silver nano painting, preferably about 4 μm thick, producing a plurality of colors.

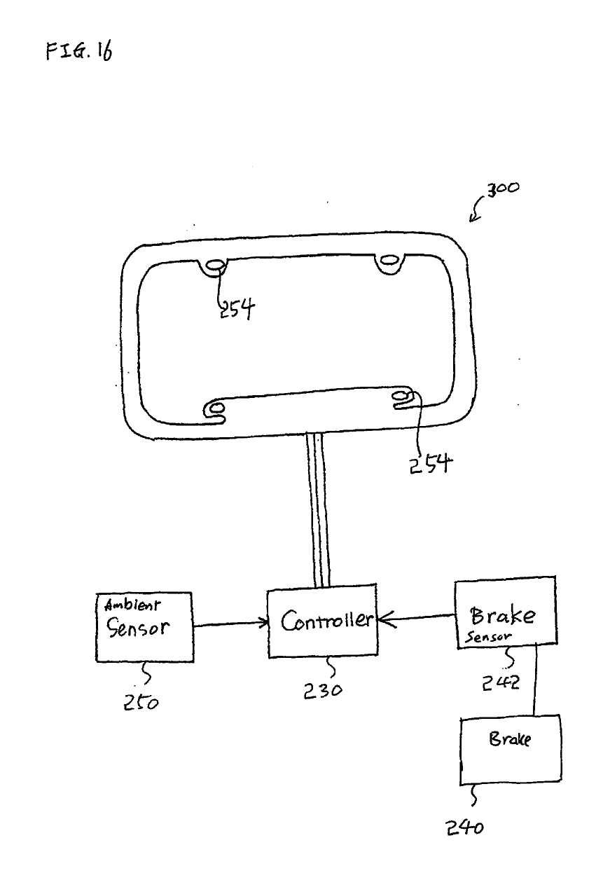

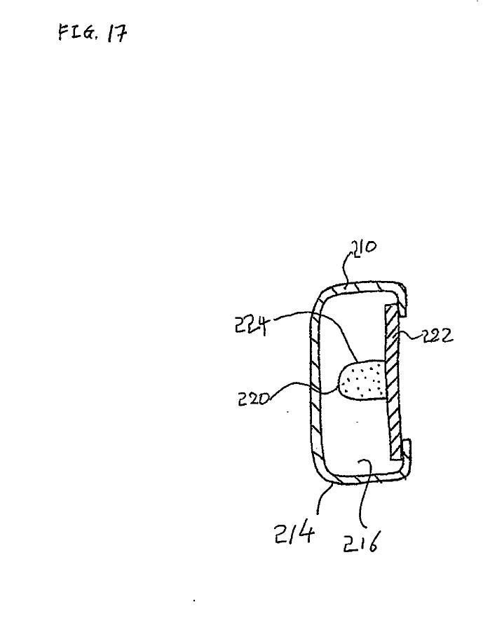

The plurality of illuminating devices may be electrically connected to a controller, which controls the brightness of the illuminating devices as shown in FIG. 16.

The controller may get inputs from a brake system of the automobile. The brightness of the illuminating devices can be controlled by the status of the brake system.

In a certain embodiment of the invention, the brightness is nil when it is a daytime and the brake is not stepped on, which renders the bi-color license plate frame to look opaque and metallic. At night, however, the brightness is set to be a first magnitude when the brake is not stepped on, and to be a second magnitude when the brake is stepped on. The first magnitude may be lower than the second magnitude. Thus, the bi-color license plate frame is reddish at night, and whenever the driver steps on the brake the bi-color license plate frame go much more reddish, in order to warn the other drivers in the following cars.

As shown in FIG. 16, the bi-color license plate frame may include a light sensor that senses the ambient light to determine if it is nighttime or daytime. Therefore, the controller may receive inputs from the brake system and the light sensor, and determine when to turn on or off the illuminating devices and when to turn on them at the first magnitude or the second magnitude.

In a certain embodiment of the invention, the bi-color illuminated display may comprises: a metal look layer; one or more illuminating elements; a light diffusion layer that diffuses light from the illuminating elements, wherein the metal look layer passes light from the illuminating elements; and a controller for controlling switching on or off and brightness of the illuminating elements.

FIGS. 14 and 17 show a bi-color license plate frame 300, for surrounding a license plate of a vehicle, comprising a rectangular body 210 that comprising an aperture 212 that is adapted to show a license plate, and a wall 214 defining a hollow frame space 216 inside the wall 214; a plurality of light-emitting elements 220 contained in the frame space 216; and a controller 230 (refer to FIG. 16) that is electrically connected to the light-emitting elements 220 and that controls the light intensity of the light-emitting elements 220.

In FIG. 16, a system for the bi-color license plate frame 300 is illustrated. A brake 240 may be a part of an automobile. The controller 230 is connected with an ambient light sensor 250 that measures the intensity of ambient light, and a brake sensor 242 that is adapted to receive braking signal from the vehicle. The controller 230 controls the light intensity of the light-emitting elements 220 according to the received braking signal. The controller 230 receives necessary information from the brake 240 and the ambient light sensor 250 to determine ON or OFF and brightness of the illuminating device 220.

When the ambient light sensor 250 indicates that it is night time and the brake sensor 242 indicates that that the brake is not stepped on, the controller 230 sets the light intensity at a first magnitude. When the ambient light sensor 250 indicates that it is night time and the brake sensor 242 indicates that that the brake is stepped on, the controller 230 sets the light intensity at a second magnitude. The first magnitude is lower than the second magnitude.

FIG. 17 shows that the bi-color license plate frame 300 further comprises a printed circuit board (PCB) 222 on which the light-emitting elements 220 are installed, wherein the light-emitting elements comprise light-emitting diodes (LED) 224. The number of LEDs 224 can be determined by desired brightness. In this embodiment, the bi-color license plate frame 300 includes 84 LEDs in order to obtain a surface illumination. The LED 224 and the PCB 222 are enclosed by the wall 214, and housed in the hollow frame space 216.

As shown in FIG. 19, the wall 214 of the rectangular body is translucent to the light of the light-emitting elements, and comprises a light diffusion layer 226, whereby surface illumination is provided when the light-emitting elements 220 are turned on. The light diffusion layer 226 is made of resin, wherein the resin comprises acrylonitrile butadiene styrene (ABS), or poly methyl methacrylate (PMMA), or Lexan™ depending on strength and durability, etc. that are required. The resin of the light diffusion layer is dyed in red or black color. The wall 214 of the rectangular body further comprises a silver nano painting layer 232. The thickness of the silver nano painting layer 232 is in the range of 3˜5 μm.

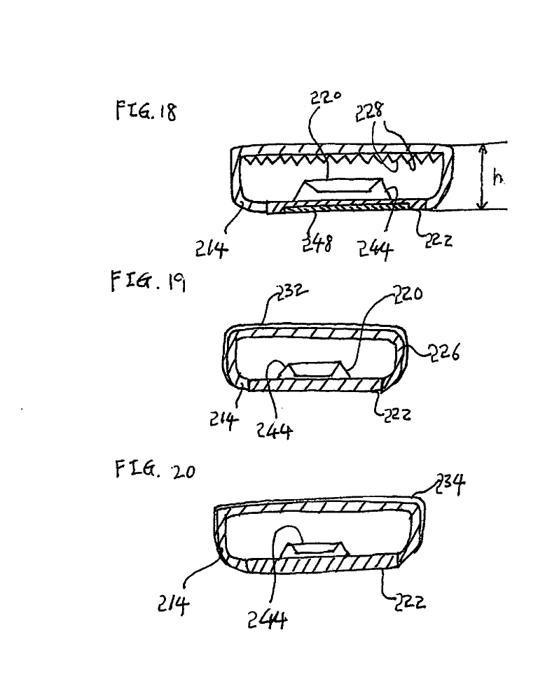

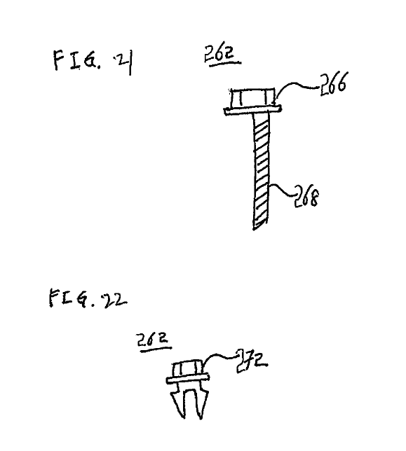

FIG. 20 shows that the wall 214 of the rectangular body may further comprise a metal coating layer 234, wherein the degree of translucency is controlled with the grains of the metal coating layer 234.

FIGS. 18˜20 show that the light emitting element 220 comprises a low profile and wide angle light emitting diode 244 that has a light emitting angle greater than one hundred ten degree. The use of low profile LEDs 244 helps to reduce the height h of the frame to 11 mm.

FIG. 18 shows that the printed circuit board 222 comprises a heat conducting plate 248 that is adapted to contact the vehicle, whereby heat generated by the light-emitting diodes 244 is dissipated to the vehicle.

Referring FIG. 18, the light diffusion layer may comprise a plurality of projections 228 that divert light rays from the light-emitting elements 220.

Referring back to FIG. 14, the bi-color license plate frame 300 further comprises a wire, or a plurality of leads 290 for electrical connection that are adapted to be connected to a wiring harness of the vehicle. The frame 300 comprises four installation holes 254 that are used in installing the frame to a vehicle.

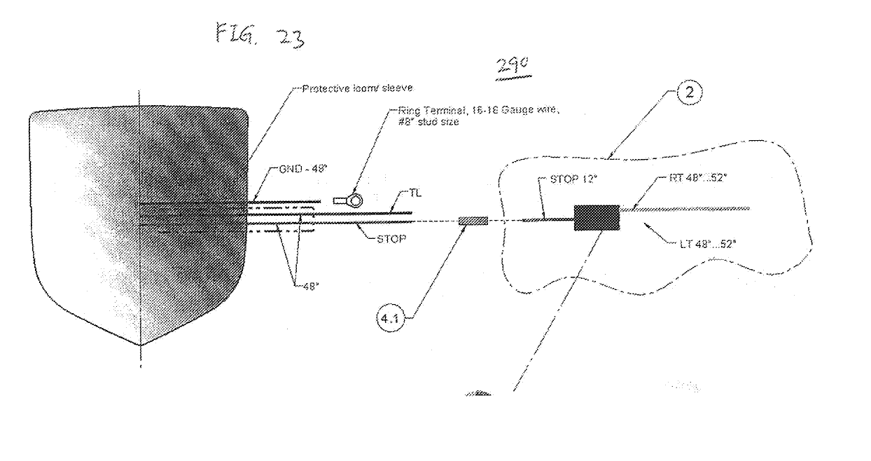

FIGS. 21 and 22 show a fastener 262 that is adapted to fasten the rectangular body 210 to the vehicle and that has a space 264 for passage of the wire 290. FIG. 21 shows that the fastener comprises a threaded screw 266 that comprises a half-cylindrical body 268. Alternatively, FIG. 22 shows that the fastener comprises a cap 272 that fits into the hole 254 provided on the rectangular body 210. One of the holes 254 is used to insert the wire 290 through it and the cap 272 has a shape of a bolt head and covers the hole 254 to provide same appearance as three other screws that are used to fix the frame 300.

FIG. 23 shows a connection module 290 that connects the illuminated emblem to the wiring harness of a vehicle. The connection module 290 responds to vehicle brake light status and provides electricity to the illuminated emblem accordingly.

The bi-color license plate frame according to the invention may be adapted to be used for automobiles including cars and motorcycles.

While the invention has been shown and described with reference to different embodiments thereof, it will be appreciated by those skilled in the art that variations in form, detail, compositions and operation may be made without departing from the spirit and scope of the invention as defined by the accompanying claims.

1. A bi-color illuminated decorative device for an automobile comprising:
a) a metal-look portion having a metal look layer, a substrate layer that supports the metal look layer, and a plurality of illuminating elements, wherein the illuminating elements are arranged to conform to the shape of the metal-look portion, wherein the metal look layer and the substrate layer pass light from the illuminating elements; and
b) a controller that is electrically connected to the illuminating elements and that controls the light intensity of the illuminating elements, wherein the controller comprises an ambient light sensor that measures the intensity of ambient light, and a brake sensor that is adapted to receive braking signal from the vehicle;
wherein the controller controls the light intensity of the light-emitting elements according to the received braking signal, wherein when the ambient light sensor indicates that it is night time and the brake sensor indicates that that the brake is not stepped on, the controller set the light intensity at a first magnitude, wherein when the ambient light sensor indicates that it is night time and the brake sensor indicates that that the brake is stepped on, the controller set the light intensity at a second magnitude, wherein the first magnitude is lower than the second magnitude.

2. The device of claim 1, further comprising a non-metal look colored portion that is adjacent to the metal-look portion.

3. The device of claim 2, wherein the metal-look portion further comprises a light diffusion layer that diffuses light from the illuminating elements.

4. The device of claim 3, wherein the light diffusion layer comprises a plurality of projections that project from the substrate layer and divert light rays from the illuminating elements.

5. The device of claim 3, wherein metal look layer comprises a metal coating layer, wherein the degree of translucency is controlled with the grains of the metal coating layer.

6. The device of claim 5, wherein the metal-coating layer comprises a silver nano painting layer.

7. The device of claim 6, wherein the wherein the thickness of the silver nano painting layer is in the range of 3˜5 μm.

8. The device of claim 5, further comprising a printed circuit board on which the illuminating elements are installed, wherein the illuminating elements comprise light-emitting diodes.

9. The device of claim 8, wherein the illuminating element further comprises a light guiding element that guides the light from the light-emitting diodes within a predetermined angle.

10. The device of claim 9, wherein the predetermined angle is greater than one hundred ten degree.

11. The device of claim 10, wherein the printed circuit board comprises a heat conducting plate that is adapted to contact the vehicle, whereby heat generated by the light-emitting diodes is dissipated to the vehicle.

12. The device of claim 11, wherein the further comprising a wire that is adapted to be connected to a wiring harness of the vehicle.

13. The device of claim 12, wherein the substrate layer is made of semi-transparent plastic resin.

14. The device of claim 13, wherein the metal-look portion further comprises a clear coating on top of the metal look layer.
